(19) United States
(12) Patent Application Publication
(10) Pub. No.: US 2006/0023883 A1
(43) Pub. Date: Feb. 2, 2006

(54) System, method and apparatus for secure data transmissions within an information handling system

(75) Inventors: David Konetski, Austin, TX (US); William F. Sauber, Georgetown, TX (US); Neeraj Srivastava, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 10/899,896

(22) Filed: Jul. 27, 2004

(51) Int. Cl. H04K 1/00

(52) U.S. Cl. 380/255

(57) ABSTRACT

A system, method and apparatus are provided for creating a secure data path using a peer-to-peer enabled Peripheral Component Interconnect-Express (PCI-E) data communications path. In an exemplary implementation, a content receiver and rendering subsystem are provided, each aware of the other. The content receiver is operable to receive protected content from a source such as a set-top box. After authenticating the rendering subsystem as an approved content recipient, the content receiver preferably communicates decrypted content signals to the rendering subsystem via a peer-to-peer enabled PCI-E communications channel between the device systems. Once desired rendering processing operations have been performed on the decrypted content, the rendering subsystem may encrypt the rendered content before transmission to an associated display device for presentation.

### TECHNICAL FIELD

The present invention relates generally to secure data communications and, more particularly, to providing a secure communications path in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the digital distribution of copyright protected content increases, so do the concerns of copyright holders and system suppliers regarding the use of information handling systems to violate such copyrights. In light of the ease with which information handling system may be used manipulate digital content, copyright holders and system suppliers have a keen interest in the development of robust copy protection systems ensure their copyrights are not violated through unlicensed or illegal replication, redistribution, etc.

The copy protection demands fro copyright protected content present a number of challenging issues for the information handling system and personal computing industries. One of the most challenging issues is defining a robust architecture that satisfies the copyright or content owner's security concerns and avoids burdening information handling system or personal computer architecture with undue costs or complexity. Taking into consideration the number of content protection schemes that must be supported by a conventional entertainment personal computer system, an already challenging issue is further exacerbated.

An existing attempt at meeting the demands of copyright owners is a brute force approach that requires the target content to remain in an encrypted or protected form at all times during movement of the content between subsystems of the information handling system. In its implementation, this method of securing copyright protected content requires decryption capabilities at every subsystem input and encryption capabilities at every subsystem output in order for the content to be processed and/or rendered. Supporting multiple encryption schemes further complicates matters by requiring subsystems to comprehend the multiple, possibly changing, encryption schemes. While an alternative to this solution is to provide for the input of the subsystem to transcribe the content into a standard content protection scheme, the requirement of encryption to the standard scheme and decryption before rendering operations remain to tax system performance and cost.

### SUMMARY

In accordance with teachings of the present disclosure, a method for securely communicating protected content signals within an information handling system is provided. The method preferably includes, authenticating, by a signal source, a content receiver operable to process a protected content signal and communicating a protected content signal from the signal source to the authenticated content receiver. The method preferably further includes removing protection from the protected content signal. In addition, the method preferably includes authenticating a rendering system operable to perform at least one rendering processing operation on a received unprotected content signal and transferring the unprotected content signal from the content receiver to the authenticated rendering system over a peer-to-peer enabled peripheral component interconnect-express data channel. Further, the method preferably includes encrypting a content signal processed for rendering for transmission to a display and transmitting the encrypted content signal to the display.

Further in accordance with teachings of the present disclosure, an information handling system including a peer-to-peer enabled peripheral component interconnect-express data path coupling a content receiver and a rendering system is provided. Preferably, the content receiver is operable to decrypt an encrypted content signal received from at least one content source and securely communicate the decrypted content signal to the rendering system via the peer-to-peer enabled peripheral component interconnect-express data path.

Still further in accordance with teachings of the present disclosure, a content viewing system including at least one display and an information handling system is provided. In an exemplary embodiment, a content receiver associated with the information handling system and operable to receive a content signal from at least one content signal source is included. An exemplary embodiment preferably further includes a rendering system associated with the information handling system and is preferably operable to perform at least one rendering processing operation on a content signal received from the content receiver. In addition, an exemplary embodiment may also include a secure peer-to-peer enabled data path coupling the content receiver to the rendering system, the secure data path operable to communicate an unencrypted content signal from the content receiver to the rendering system.

Also in accordance with teachings of the present disclosure, a content receiver for use in an entertainment enabled information handling system is provided. In an exemplary embodiment, the content receiver preferably includes a communications port operable to receive a protected content signal from at least one signal source and a communications port operable to communicate a received content signal to a rendering system. Further, the exemplary content receiver is preferably also operable to perform decryption on the protected content signal, access a peer-to-peer enabled peripheral component interconnect-express (PCI-E) data path between the content receiver and the rendering system, and communicate the decrypted content signal to the rendering system over the peer-to-peer enabled PCI-E data path.

Teachings of the present disclosure provide a technical advantage in at least one aspect through provision of a secure, dedicated data path over which protected content may be communicated with minimal risk of loss.

Teachings of the present disclosure provide a further technical advantage through provision of data channel protected against software attacks through ensuring that neither unencrypted nor intermediate formats of protected data need ever be resident in main memory.

Teachings of the present disclosure provide an additional technical advantage in that an information handling system architecture formed in accordance with teachings of the present disclosure removes a need to re-encrypt content for transport through the information handling system.

Teachings of the present disclosure provide still additional technical advantages in that an information handling system architecture formed in accordance with teachings of the present disclosure allow the cost and complexity of robust content protection to reside within a content receiver subsystem.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a schematic diagram depicting an exemplary embodiment of an information handling system providing a secure peer-to-peer peripheral component interconnect-express data path according to teachings of the present disclosure;

FIG. 2 is a schematic diagram depicting an alternate exemplary embodiment of an information handling system providing a secure peer-to-peer peripheral component interconnect-express data path according to teachings of the present disclosure;

FIG. 3 is a schematic diagram depicting an alternate exemplary embodiment of an information handling system providing a secure peer-to-peer peripheral component interconnect-express data path according to teachings of the present disclosure; and

FIG. 4 is a flow diagram depicting an exemplary embodiment of a method for receiving and processing for rendering a content signal according to teachings of the present disclosure.

### DETAILED DESCRIPTION

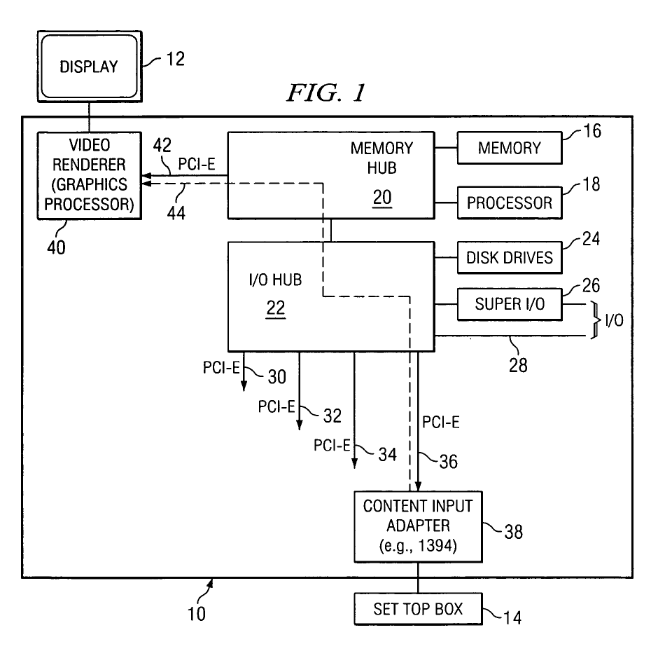

Preferred embodiments and their advantages are best understood by reference to FIGS. 1 through 4, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to FIG. 1, a schematic diagram depicting an exemplary embodiment of an information handling system providing a secure peer-to-peer data path according to teachings of the present disclosure is shown. As illustrated in FIG. 1, an entertainment system operable for use with teachings of the present disclosure may include information handling system 10 and display 12. Information handling system 10 may be coupled to one or more signal sources, such as set top box 14. In an alternate embodiment, display 12 and/or a signal source may be incorporated within exemplary information handling system 10, e.g., in the instance of certain entertainment information handling system implementations.

In an exemplary embodiment of information handling system 10, memory 16 and processor 18 are preferably included. Memory 16 and processor 18 preferably cooperate to store and execute, respectively, one or more instructions of a program of instructions. As shown in FIG. 1, memory 16 and processor may be operably coupled via memory hub 20.

In addition to memory 16 and processor 18, exemplary information handling system 10 may also include input/output (I/O) hub 22. I/O hub 22 may be provided coupled to memory hub 20 such that memory 16 and processor 18 may obtain input from and direct output to one or more devices operably coupled to I/O hub 22. I/O hub 22 may also be provided to allow devices operably coupled thereto to obtain input from and direct output to other devices operably coupled thereto.

In an embodiment of exemplary information handling system 10 deployed as an entertainment personal computing system, or otherwise deployed one or more disk drives 24 may be provided operably coupled to I/O hub 22. Disk drives 24 may include, without limitation, one or more fixed disk drives, compact disc (CD) drives, digital versatile disc (DVD) drives or other removable media drives. Disk drives 24 may be also be leveraged to maintain and provide access to one or more operating systems, specialty software applications as well as other programs of instructions.

Also preferably connected to I/O hub 22 in exemplary information handling system 10 are one or more devices such as super I/O device 26 and/or other I/O ports 28, such as a serial or universal serial bus (USB) port. In addition to super I/O device 26 and additional I/O ports 28 are one or more expansion ports 30, 32, 34 and 36. Expansion ports 30, 32, 34 and 36 may be implemented using a single expansion technology or by leveraging a plurality of expansion port technologies. For example, expansion ports 30, 32, 34 and 36 may include, without limitation, industry standard architecture (ISA) data busses and ports, extended industry standard architecture (EISA) data busses and ports, peripheral component interconnect (PCI) data busses and ports, peripheral component interconnect-extended (PCI-X) data busses and ports, peripheral component interconnect-express (PCI-E) data links or interconnects and ports, as well as other expansion port data communication technologies.

Expansion ports 30, 32, 34 and 36 may be used to incorporate alternate and additional functionality into exemplary information handling system 10. For example, expansion port 36 may be based on PCI-E technology and include a PCI-E data link or interconnect and corresponding expansion slot operable to enable a cable modem, television tuner card, cable card, as well as myriad other devices to be added to exemplary information handling system 10. As shown in FIG. 1, expansion port 36 utilizes PCI-E technology and has coupled thereto content input adapter 38. As suggested above, content input adapter 38 may take myriad forms, according to teachings of the present disclosure.

Exemplary information handling system 10 preferably also includes a video rendering system or subsystem 40. As illustrated in FIG. 1, video rendering system or subsystem 40 may be provided coupled to memory hub 20. In an alternate embodiment rendering system 40 and memory hub 20 may be integrated into a single device. In typical operation, rendering system 40 may receive one or more signals on which rendering system 40 may perform one or more rendering processing operations before passing the content signals processed for rendering on to display 12 for communication to a viewing user.

In accordance with teachings of the present disclosure, exemplary information handling system 10 preferably couples content input adapter or receiver 38 to rendering system 40 using one or more data links or interconnects based on peripheral component interconnect-express (PCI-E) technology. As shown in FIG. 1, rendering system 40 may be coupled to content input adapter or receiver 38 through PCI-E expansion port 36 and associated link or interconnect structures via I/O hub 22 and memory hub 20, with rendering system 40 being coupled to memory hub 20 via PCI-E based data path 42. Secure, peer-to-peer data path 44 of FIG. 1 includes PCI-E data path 42 between rendering system 38 and memory hub 20, memory hub 20 in communication with I/O hub 22 and the PCI-E data path of expansion port 36. Data path 44 may be effected by enabling peer-to-peer operability on the associated PCI-E structures and related devices.

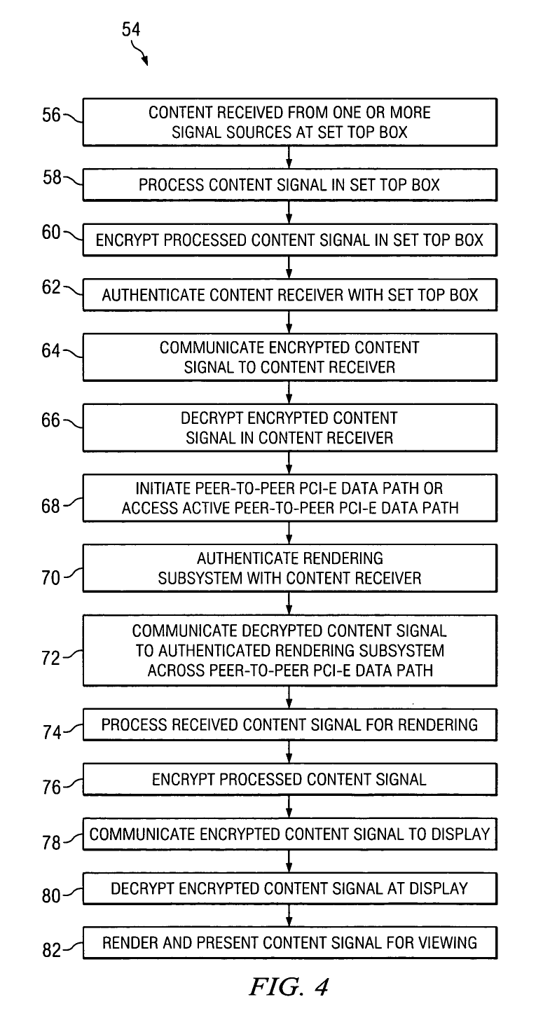

In accordance with teachings of the present disclosure, provision of a PCI-E data path between rendering system 40 and content input adapter or receiver 38 enables the creation of a secure data path over which protected content may be transmitted. More specifically, enabling a PCI-E data path between rendering system 40 and content input adapter or receiver 38 in a peer-to-peer mode creates a secure, dedicated data path over which unencrypted content may be communicated substantially without risk of unauthorized access. Additional detail regarding the operation of exemplary information handling system 10 is discussed below with respect to FIG. 4.

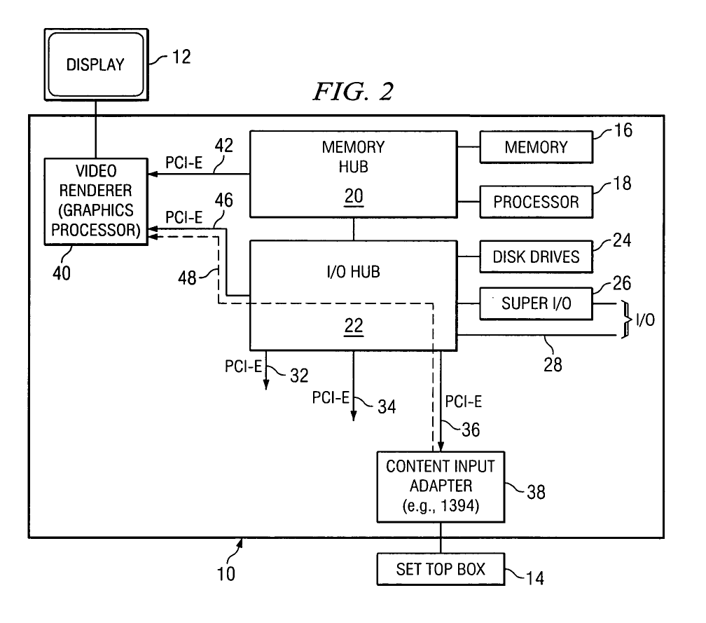

Referring now to FIG. 2, an alternate implementation of a secure data path between rendering system 40 and content input adapter or receiver 38 is shown according to teachings of the present disclosure. As illustrated in FIG. 2, a secure data path between rendering system 40 and content input adapter 38 may be formed using PCI-E connector extension 46. The remaining leg of secure data path 48 illustrated in FIG. 2 may be defined by the PCI-E data path of expansion port 36 between I/O hub 22 and content input adapter or receiver 38. Similar to data path 44 of FIG. 1, data path 48 of FIG. 2, preferably operating in a peer-to-peer operating mode, enables unencrypted or otherwise unprotected content to be passed between rendering system 40 and content input adapter or receiver 38 without the risk of unauthorized access.

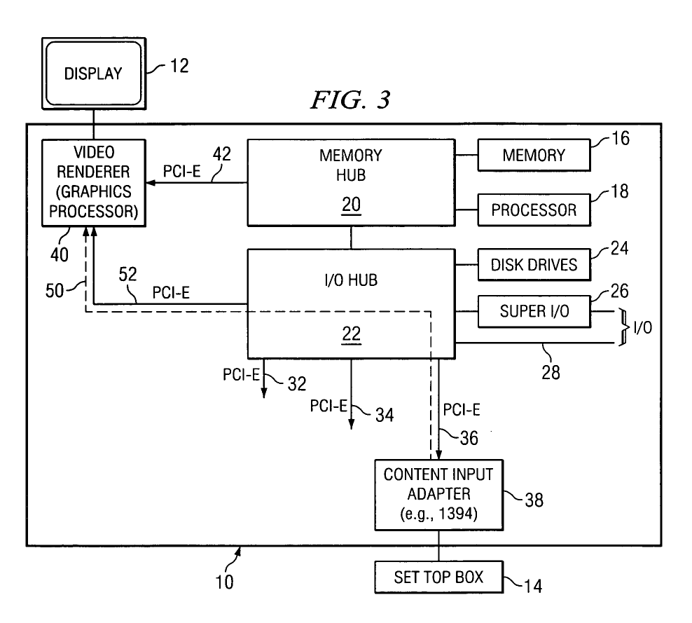

Referring now to FIG. 3, an alternate implementation of a PCI-E data path between rendering system 40 and content input adapter or receiver 38 is shown according to teachings of the present disclosure. Secure data path 50 of FIG. 3 may be defined by the PCI-E structure forming a portion of expansion port 36 and disposed between I/O hub 22 and content input adapter or receiver 38 and cabled PCI-E connection 52 between I/O hub 22 and rendering system 40. As with secure data paths 44 and 48 of FIGS. 1 and 2, respectively, data path 50, when operated in a peer-to-peer mode enables unencrypted or otherwise unprotected content to be securely communicated between content input adapter or receiver 38 and rendering system 40. Further alternative embodiments of coupling rendering system 40 and content receiver 38 may be employed in accordance with teachings of the present disclosure.

Referring now to FIG. 4, a flow diagram depicting an exemplary embodiment of the operation of an information handling system incorporating teachings of the present disclosure is shown. It should be understood that various modifications may be made to method 54 of FIG. 4 without departing from the spirit and scope of the teachings discussed herein.

Beginning at 56, set top box 14 or other content source may receive a content signal from one or more distant signal sources, for example from a cable content provider, satellite content provider, as well as other content providers. Once set top box 14 is in possession of a content signal, set top box 14 may be considered a signal source with respect to exemplary information handling system 10.

Having received all or a portion of a content signal in set top box 14 or other content device, method 54 preferably proceeds to 58. At 58, set top box 14 or other content device may perform one or more operations on the received content signal. Following processing of the received content signal in accordance with preferred functionality of set top box 14 or other content device, method 54 preferably proceeds to 60.

At 60, set top box 14 or other content device preferably provides at least one form of protection for the processed content signal prior to transmitting the processed content signal to exemplary information handling system 10. For example, set top box 14 may encrypt a signal received from a cable provider and processed in the set top box 14 using Digital Transmission Content Protocol (DTCP) or other encryption technique prior communicating the content signal to exemplary information handling system 10.

At 62, content input adapter or receiver 38 of exemplary information handling system 10 is preferably authenticated with set top box 14. In one aspect, authentication between set top box 14 and content receiver 38 may be performed in an attempt to ensure that set top box 14 minimizes the risk of transmitting protected content to suspect or unauthorized devices. In addition, authorization procedures performed at 62 may occur on a per transaction, per session, per data volume, per frame or other basis.

Once content input adapter or receiver 38 has been authenticated with set top box 14, method 54 preferably proceeds to 64 where the processed content signal may be transmitted form set top box 14 to content input adapter or receiver 38 of exemplary information handling system 10. In one embodiment of teachings of the present disclosure, set top box may communicate the processed and protected content signal to exemplary information handling system 10 over a data path based on the FireWire or 1394 protocol promulgated by the Institute of Electrical and Electronic Engineers. Alternative connections between set top box 14 and content receiver 38 may also be employed in accordance with teachings of the present disclosure.

Upon receipt of the processed, protected content signal in the content input adapter or receiver 38, the protected content signal is preferably decrypted or otherwise stripped of its protection at 66. In accordance with teachings of the present disclosure, one advantage presented by the teachings discussed herein is that much of the cost and complexity of decrypting myriad content signal formats may be implemented in a single device, such as content input adapter or receiver 38. As such, content input adapter or receiver 38 is preferably operable to decrypt DTCP encrypted content as well as a variety of other potential encryption or protection schemes.

At 68, method 54 preferably provides for creation or verification of a peer-to-peer enabled, PCI-E data path between content input adapter or receiver 38 and rendering system 40. In one aspect, method 54 may provide for a determination as to whether a peer-to-peer data path is presently operational at 68. If it is determined that a peer-to-peer data path is currently operational between content receiver 38 and rendering system 40 at 68, method 54 may proceed to 70.

Alternatively, method 54 may provide for initiation of a peer-to-peer enabled data path between content receiver 38 and rendering system 40 at 68. For example, if it is determined that a peer-to-peer data path is not currently enabled, operations may be performed to initiate such a data path at 38. Alternatively, method 54 may, as a default operation, provide for initiation of a peer-to-peer data path between content receiver 38 and rendering system 40 at 68 to ensure such as a data path is operational and to ensure that the rendering system is authenticated prior to transmission of unprotected content from content receiver 38 to rendering system 40.

After initiating or accessing an active peer-to-peer enabled, PCI-E data path between content receiver 38 and rendering system 40, method 54 preferably proceeds to 70. At 70, method 54 preferably provides for authentication of rendering system 40 with content receiver 38. Similar to the authentication described above, authentication operations may be performed on a per frame, per transaction, per session, per data volume or other basis.

As with the authentication preferably performed between set top box 14 and content receiver 38, the authentication preferably performed between content receiver 38 and rendering system 40 may be varied. In one embodiment, a Diffie-Hellman algorithm may be used between content receiver 38 and rendering system 40 to perform authentication operations. Alternative algorithms and authentication methods may be employed in accordance with teachings of the present disclosure.

In accordance with teachings of the present disclosure, authentication between rendering system 40 and content receiver 38 may carry with it additional benefits. In one embodiment, the content receiver included in an information handling system may be shipped to an end user having authentication data embedded therein. Similarly, the rendering system of such an information handling system may also have within in it factory embedded information. In such a case, should an end user alter one or more aspects of the factory created information handling system, for suspect or legitimate purposes, such a system may be configured to fail the authentication procedures at 70 of method 54. As a result, the risk of unauthorized access to unprotected content transmitted between the rendering system and content receiver may be minimized.

In a further embodiment, software revocation of authentication operations may be enabled. In such a system, software may be included on an information handling system that is operable to detect alterations made to the system. Suspect changes to the system detected by the software may result in a disabling of authentication capabilities between the rendering system and content receiver in an effort to ensure unauthorized access to unprotected content is not provided. A software authentication revocation application may be further configured to perform one or more tests on the associated information handling system and/or rendering system and content receiver combination to determine whether a suspect configuration is present as a portion of the authentication or re-authentication testing.

At 72, following authentication of rendering system 40 with content receiver 38, content receiver 38 preferably transmits the unprotected or unencrypted content signal to rendering system 40 over a secure peer-to-peer enabled, PCI-E data path. Upon receipt of the unprotected or unencrypted content signal in the rendering system, one or more rendering processing operations may be performed on the content signal by rendering system 40 at 74. In contrast to many existing or theoretical implementations, an exemplary information handling system incorporating teachings of the present disclosure needn't decrypt received content signals before beginning rendering processing operations. Instead, an exemplary information handling system incorporating teachings of the present disclosure may begin rendering processing operations upon receipt of unprotected content signals from content receiver 38, immediately if desired.

Following performance of one or more rendering processing operations on the unprotected content signal received from content receiver 38, method 54 may proceed to 76. At 76, rendering system 40 preferably wraps the rendered signal in one or more layers of protection prior to transmission of the content signals processed for rendering to display 12. In one embodiment, rendering system 40 may wrap content signals processed for rendering in High-Bandwidth Digital Content Protection (HDCP). Alternative forms of encryption or protection may be implemented for content signals processed for rendering in rendering system 40.

At 78, the content signals processed for rendering by rendering system 40 may be communicated or transmitted to display 12. In one embodiment, transmission of protected content from rendering system 40 to display 12 may be implemented over a digital visual interface (DVI). Other data communications technologies may be used to communicate content signals from rendering system 40 to display 12.

Upon receipt of a protected content signal processed for rendering by rendering system 40, display 12 may decrypt the protected content signal at 80. Once the protected content signals have been decrypted, display 12 may present the content signals for viewing by a user.

Although the disclosed embodiments have been described in detail, it should be understood that various changes, substitutions and alterations can be made to the embodiments without departing from their spirit and scope.

What is claimed is:

1. A method for securely communicating protected content signals within an information handling system, comprising:
authenticating, by a signal source, a content receiver operable to process a protected content signal;
communicating a protected content signal from the signal source to the authenticated content receiver;
removing protection from the protected content signal;
authenticating a rendering system operable to perform at least one rendering processing operation on a received unprotected content signal;
transferring the unprotected content signal from the content receiver to the authenticated rendering system over a peer-to-peer enabled peripheral component interconnect-express (PCI-E) data channel;
encrypting a content signal processed for rendering for transmission to a display; and
transmitting the encrypted content signal to the display.

2. The method of claim 1, further comprising decrypting the protected content signal by the authenticated content receiver.

3. The method of claim 1, further comprising encrypting the content signal processed for rendering by the rendering system.

4. The method of claim 1, further comprising:
decrypting the encrypted content signal by the display; and
presenting the decrypted content signal for viewing on the display.

5. The method of claim 1, further comprising:
evaluating whether a change concerning the content receiver, the data channel or the rendering system has occurred in the information handling system; and
ceasing content processing operation in response to a determination that a change concerning the content receiver, the data channel or the rendering system has occurred.

6. An information handling system, comprising:
a peer-to-peer enabled peripheral component interconnect-express (PCI-E) data path coupling a content receiver and a rendering system; and
the content receiver operable to decrypt an encrypted content signal received from at least one content source and securely communicate the decrypted content signal to the rendering system via the peer-to-peer enabled peripheral component interconnect-express data path.

7. The information handling system of claim 6, further comprising the content receiver operable to perform at least one authentication action responsive to an authentication request from a signal source.

8. The information handling system of claim 6, further comprising the rendering system operable to perform at least one authentication action responsive to an authentication request from the content receiver.

9. The information handling system of claim 6, further comprising the rendering system operable to perform at least one rendering operation on the received decrypted content signal.

10. The information handling system of claim 6, further comprising the rendering system operable to encrypt a content signal processed by the rendering system prior to transmission of the processed content signal to a display.

11. The information handling system of claim 6, further comprising the peripheral component interconnect-express data path including a PCI-E link coupling the content receiver to an I/O hub, the I/O hub coupled to a memory hub and a PCI-E link coupling the memory hub to the rendering system.

12. The information handling system of claim 6, further comprising the PCI-E data path including a PCI-E link coupling the content receiver to an I/O hub and a PCI-E connector extension coupling the I/O hub to the rendering system.

13. The information handling system of claim 6, further comprising the PCI-E data path including a PCI-E link coupling the content receiver to an I/O hub and a PCI-E cable connection coupling the I/O hub to the rendering system.

14. The information handling system of claim 6, further comprising at least one of the content receiver and the rendering system operable to detect a change in the rendering system and content receiver respectively and disable content signal communications in response to a detected change.

15. A content viewing system including at least one display and an information handling system, comprising:
a content receiver associated with the information handling system and operable to receive a content signal from at least one content signal source;
a rendering system associated with the information handling system and operable to perform at least one rendering processing operation on a content signal received from the content receiver; and
a secure peer-to-peer enabled data path coupling the content receiver to the rendering system, the secure data path operable to communicate an unencrypted content signal from the content receiver to the rendering system.

16. The content viewing system of claim 15, further comprising a peripheral component interconnect-express (PCI-E) link operating in a peer-to-peer enabled mode forming at least a portion of the secure data path coupling the content receiver to the rendering system.

17. The content viewing system of claim 15, further comprising the content receiver operable to detect an alteration in at least one of the rendering system and the secure peer-to-peer enabled data path and disable communication of content signals from the content receiver.

18. The content viewing system of claim 15, further comprising the rendering system operable to detect an alteration in at least one of the content receiver and the secure peer-to-peer enabled data path and disable communication of content signals from the content receiver.

19. The content viewing system of claim 15, further comprising the content receiver operable to cooperate in an authentication operation between the content receiver and at least one signal source.

20. The content viewing system of claim 15, further comprising the rendering system operable to cooperate in an authentication operation between the content receiver and the rendering system.

21. The content viewing system of claim 15, further comprising the content receiver operable to receive an encrypted content signal from the signal source and decrypt the encrypted content signal prior to communication of the unencrypted content signal to an authenticated rendering system over the secure peer-to-peer enabled data path.

22. The content viewing system of claim 15, further comprising the rendering system operable to perform one or more rendering processing operations on the received unencrypted content signal, encrypt the content signal processed for rendering and communicate the encrypted content signal to the display.

23. A content receiver for use in an entertainment enabled information handling system, comprising:
a communications port operable to receive a protected content signal from at least one signal source;
a communications port operable to communicate a received content signal to a rendering system; and
the content receiver operable to perform at least one form of decryption on the protected content signal, access a peer-to-peer enabled peripheral component interconnect-express (PCI-E) data path between the content receiver and the rendering system, and communicate the decrypted content signal to the rendering system over the peer-to-peer enabled PCI-E data path.

24. The content receiver of claim 23, further comprising the content receiver to cooperate with the signal source for purposes of verifying an authentication of the content receiver to receive the protected content signal.

25. The content receiver of claim 23, further comprising the content receiver operable to authenticate the rendering system as an approved receiver of the decrypted content signal.

26. The content receiver of claim 23, further comprising the content receiver operable to decrypt a plurality of forms of protected content signal encryption schemes.

27. The content receiver of claim 23, further comprising the content receiver operable to detect an alteration in the information handling system and to disable communication of decrypted protected content signal in response to a detected alteration in the information handling system.
